(19) United States
(12) Patent Application Publication
(10) Pub. No.: US 2011/0117875 A1
(43) Pub. Date: May 19, 2011

(54) Emergency mode operating method and mobile device adapted thereto

(75) Inventors: Se Wan Oh, Suwon-si (KR); Jong Seok Hong, Yongin-si (KR)

(73) Assignee: Samsung Electronics Co., Ltd., Suwon-si (KR)

(21) Appl. No.: 12/927,463

(22) Filed: Nov. 16, 2010

(30) Foreign Application Priority Data
Nov. 16, 2009 (KR) 10-2009-0110415

(51) Int. Cl. H04M 11/04

(52) U.S. Cl. 455/404.1

(57) ABSTRACT

An emergency mode operating method and a mobile device adapted to the method are provided. An emergency phone number is extracted using received DTMF tones. An emergency message and an outgoing emergency call are transmitted via the extracted emergency phone number. The method includes receiving Dual Tone Multi-Frequency (DTMF) tones from the other mobile device when the mobile device is operated in a call mode, acquiring an emergency phone number using a phone number based on the received DTMF tones, and operating an emergency mode based on the acquired emergency phone number.

### CROSS-REFERENCE TO RELATED APPLICATION(S) AND CLAIM OF PRIORITY

The present application is related to and claims the benefit of priority under 35 U.S.C. §119(a) to a Korean patent application filed in the Korean Intellectual Property Office on Nov. 16, 2009, and assigned Serial No. 10-2009-0110415, the entire disclosure of which is hereby incorporated by reference.

### TECHNICAL FIELD OF THE INVENTION

The present invention relates to emergency call systems, and more particularly, to a method for automatically executing an emergency mode when an emergency occurs during a call. This invention also relates to a mobile device adapted to the method.

### BACKGROUND OF THE INVENTION

With the development of electronic technology, mobile devices have more functions, thereby allowing users to conveniently use the services.

In recent years, mobile devices have been equipped with an emergency reporting function. The emergency reporting function (an emergency mode) refers to a function that allows a user of a mobile device, placed in an emergency, to transmit an emergency message (e.g., an SOS message) to a receiver who was previously registered to the user's mobile device, for example authorities or another user who uses his/her mobile device, so that the receiver can recognize the user's emergency. When another mobile device has received the emergency message from the mobile device, another user makes a call to the phone number received together with the emergency message, thereby dealing with the emergency information.

In general, mobile devices support an emergency mode where they can transmit an emergency message or make an emergency call via a previously registered phone number when an emergency occurs. In conventional mobile devices, an emergency mode can be provided only if the user sets a condition by operating a particular key of an input mechanism installed in the mobile device. In that case, however, if an emergency mode is not executed due to a user's operation failure or if the user cannot operate the particular key, such an emergency mode cannot be activated.

Conventional emergency modes can be supported only if mobile devices are always operated in an idle mode. That is, conventional emergency modes cannot be executed if mobile devices are busy in a particular mode, e.g., a call mode.

Therefore, conventional emergency mode operating systems are disadvantageous in that, if the user is in a situation where he/she cannot transmit an emergency message or cannot make an emergency call, for example, shock, paralysis, driving, etc., or if the mobile device cannot detect an emergency mode in a state where a user needs an emergency service during the call, such an emergency mode cannot be executed.

### SUMMARY OF THE INVENTION

To address the above-discussed deficiencies of the prior art, it is a primary object of the present invention to provide a method for supporting an emergency mode in a call mode of a mobile device.

The present invention further provides a method for supporting an emergency mode in a call mode of a mobile device, using a Dual-Tone Multi-Frequency (DTMF) tone.

The present invention further provides an emergency mode operating method that receives a DTMF tone in a call mode of a mobile device, extracts a phone number based on the received DTMF tone, and transmits an emergency message or makes an emergency call using the extracted phone number.

The present invention further provides a method for setting a 3 way call connection among a mobile device, a called mobile device busy on the line, and an emergency center of a phone number extracted via a DTMF tone when the mobile device supports an emergency mode in a call mode.

The present invention further provides the mobile devices adapted to the methods described above.

In accordance with an exemplary embodiment of the present invention, the present invention provides an emergency mode operating method of a mobile device, including: receiving Dual Tone Multi-Frequency (DTMF) tones from the other mobile device when the mobile device is operated in a call mode; acquiring an emergency phone number using a phone number based on the received DTMF tones; and operating an emergency mode based on the acquired emergency phone number.

In accordance with another exemplary embodiment of the present invention, the present invention provides a mobile device including: an RF communication unit and a controller. The RF communication unit receives Dual Tone Multi-Frequency (DTMF) tones when the mobile device is operated in a call mode and transmits an emergency message and an outgoing emergency call, created in an emergency mode, via a communication channel. The controller operates the emergency mode if a phone number based on the received DTMF tones is a preset emergency phone number

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a flow chart that describes a method for controlling an emergency mode in a system when DTMF tones correspond to a phone number of the other mobile device connected to the mobile device according to an embodiment of the present invention;

FIG. 2 illustrates a flow chart that describes a method for controlling an emergency mode in a system when DTMF tones correspond to a phone number of an emergency center according to an embodiment of the present invention;

FIG. 3 illustrates a flow chart that describes a method for controlling an emergency mode in a mobile device when DTMF tones correspond to a phone number of the other mobile device connected to the mobile device according to an embodiment of the present invention;

FIG. 4 illustrates a flow chart that describes a method for controlling an emergency mode in a mobile device when DTMF tones correspond to a phone number of an emergency center according to an embodiment of the present invention; and

FIG. 5 illustrates a schematic block diagram of a mobile device according to an embodiment of the present invention.

### DETAILED DESCRIPTION OF THE INVENTION

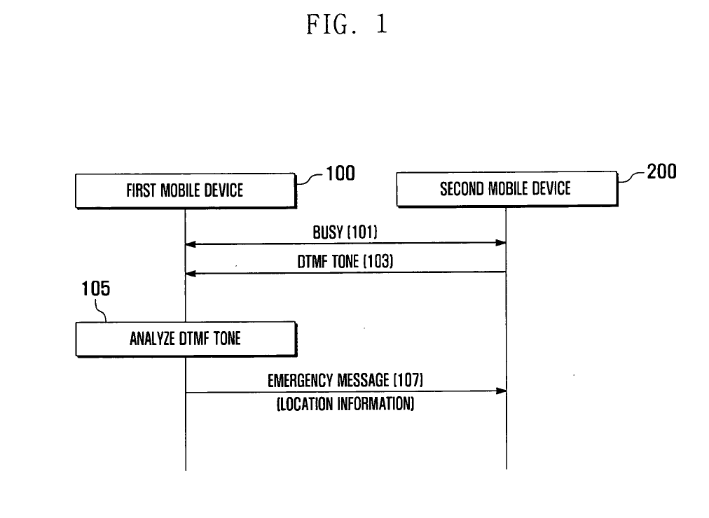

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged mobile device. This invention is related to an emergency mode method and a mobile device adapted to the method. In particular, this invention relates to a method and apparatus that can automatically transmit an emergency message or make an emergency call when an emergency occurs while a mobile device is connected with the other.

When a mobile device receives a Dual Tone Multi-Frequency (DTMF) tone from the other mobile device during a call, the mobile device extracts a phone number corresponding to the DTMF tone, and automatically transmits an emergency message or makes an emergency call to the extracted phone number.

In the following description, a mobile device and a method for supporting an emergency mode in the mobile device are explained in detail. It should be understood that the present invention is not limited to the following embodiment. It will be noted that there may be many modifications from the embodiments.

FIG. 1 illustrates a flow chart that describes a method for supporting an emergency mode in a system according to an embodiment of the present invention.

It is assumed that an emergency occurs for a user of a first mobile device 100. It is also assumed that a DTMF tone for creating an emergency phone number corresponds to the phone number of the other mobile device (e.g., a second mobile device 200) that was set to be connected with the first mobile device 100. In an embodiment shown in FIG. 1, the first mobile device 100 transmits an emergency message to the second mobile device 200 using a DTMF tone based phone number.

Referring to FIG. 1, the first mobile device 100 and the second mobile device 200 are calling each other (101). The establishment of call connection between the first and second mobile devices is achieved as follows. For example, the first mobile device 100 makes an outgoing call to a phone number of the second mobile device 200, input by a user and then is connected to the second mobile device 200. Alternatively, if the first mobile device 100 receives a call connection request from the second mobile device 200, the first mobile device 100 establishes call connection with the second mobile device 200 based on the user's input. In an embodiment of the present invention, the establishment of call connection between the first and second mobile devices is achieved via one of the mobile communication and the Internet communication.

When an emergency (e.g., shock, paralysis, etc.)-occurs for the user of the first mobile device 100 (called a first user) while the first and second mobile devices 100 and 200 are being connected to each other, the first mobile device user can report his/her emergency, via a voice, to the user of the second mobile 200 (called a second user). If the second user does not receive a reply from the first user, the second user can conclude that an emergency has occurred for the first user.

As such, when the second user recognizes an emergency for the first user, the second user can input an emergency phone number, for example, the phone number of the second mobile device 200. When the second mobile device 200 receives the second user's input in a call mode, i.e., while the first and second mobile devices are connected to each other, the second mobile device 200 creates a user input based DTMF tone and transmits it to the first mobile device 100 (103). The DTMF tone may be created according to the input signals of the keypad or touch screen of the second mobile device 200. The number of DTMF tones corresponds to the number of created input signals (key signals or touch signals). A DTMF tone is created each time the input signal is generated, and is then transmitted to the first mobile device, in order.

When the first mobile device 100 sequentially receives DTMF tones from the second mobile device 200 in a call mode, the first mobile device 100 collects the received individual DTMF tones and analyzes the collected DTMF tones (105). That is, when the first mobile device 100 receives the DTMF tones during a call, the first mobile device 100 collects the received individual DTMF tones and creates a phone number based on the collected DTMF tones. After that, the first mobile device 100 determines whether the created phone number corresponds to at least one of the previously set emergency phone numbers.

If the created phone number corresponds to a previously set emergency phone number, the first mobile device 100 creates an emergency message and transmits the emergency message to the second mobile device 200 (107). That is, if the first mobile device 100 ascertains that the phone number created based on the DTMF tones is consistent with at least one of the previously set emergency phone numbers, the first mobile device 100 creates an emergency message. The first mobile device 100 acquires its location information according to an option, for example, by a base station or a location information receiver, and creates an emergency message containing the obtained location information. After that, the first mobile device 100 transmits the emergency message to the second mobile device 200 via the phone number of the second mobile device 200, created based on the DTMF tones.

Therefore, the second user views the emergency message from the first mobile device 100 and recognizes the first user's location, so that the second user can deal rapidly with the first user's emergency.

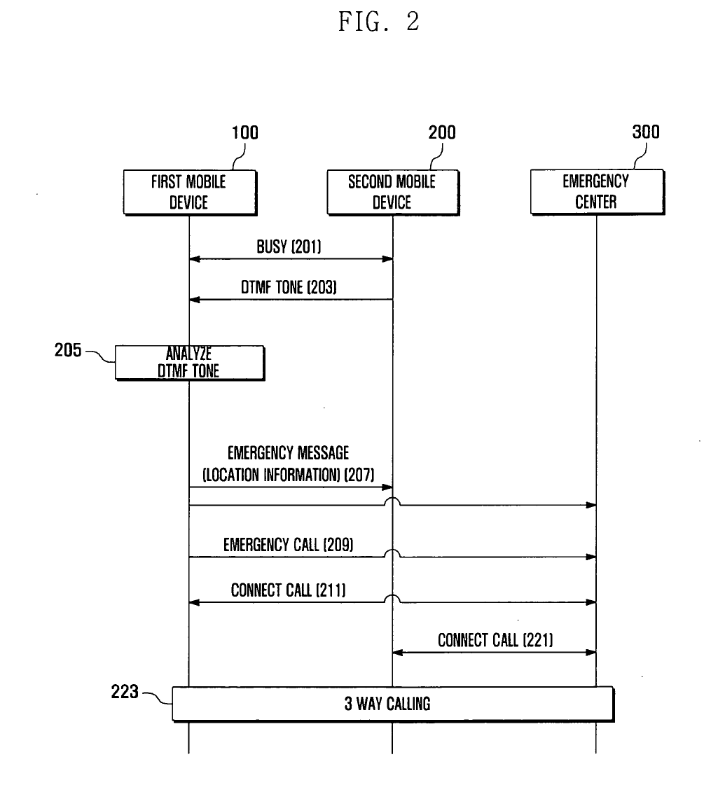

FIG. 2 illustrates a flow chart that describes a method for supporting an emergency mode in a system according to an embodiment of the present invention.

The embodiment of FIG. 2 is explained, assuming that the first user of the first mobile device 100 is in an emergency. It is also assumed that DTMF tones created in an emergency are the DTMF tones corresponding to the phone number of an emergency center 300. The emergency center 300 may be managed by a fire department, a police station, a hospital, etc. The emergency center 300 also includes other mobile devices, set to be connected with the first mobile device 100, including the second mobile device 200. In an embodiment of FIG. 2, the first mobile device 100 transmits an emergency message and makes an outgaining call, using a phone number created based on DTMF tones.

Referring to FIG. 2, the first mobile device 100 and the second mobile device 200 are connected to each other (201). In an embodiment of the present invention, the establishment of a call connection between the first and second mobile devices is achieved via one of the mobile communication and the Internet communication.

When the second mobile device 200 detects an emergency, as described in FIG. 1, in a call mode where the second mobile device 200 is connected with the first mobile device 100, the second mobile device 200 creates DTMF tones, based on the second user's input and transmits the DTMF tones to the first mobile device 100 (203). The DTMF tone may be created according to the input signals of the keypad or touch screen of the second mobile device 200. The number of DTMF tones corresponds to at least one of the phone numbers of the emergency center 300, the second mobile device 200, and other phone numbers. In the following description, it is assumed that the DTMF tones correspond to the phone number of the emergency center 300.

When the first mobile device 100 sequentially receives DTMF tones from the second mobile device 200 in a call mode, the first mobile device 100 collects the received individual DTMF tones and analyzes the collected DTMF tones (205). That is, when the first mobile device 100 receives the DTMF tones during a call, the first mobile device 100 collects the received individual DTMF tones and creates a phone number based on the collected DTMF tones. After that, the first mobile device 100 determines whether the created phone number corresponds to at least one of the previously set emergency phone numbers.

If the created phone number corresponds to a previously set emergency phone number, the first mobile device 100 creates an emergency message and transmits the emergency message to the second mobile device 200 and the emergency center 300 (207). Although the embodiment of FIG. 2 is implemented in such a way that the emergency message is transmitted to both of the second mobile device 200 and the emergency center 300, it can be modified so that the emergency message is transmitted only to one of them according to the options (for example, a three way calling).

When the first mobile device 100 creates an emergency message, the first mobile device 100 can extract the phone number of the second mobile device 200 that is currently connected with the first mobile device 100. The first mobile device 100 can transmit the emergency message to the extracted phone number of the second mobile device 200 and the phone number created based on the DTMF tones. The first mobile device 100 acquires its location information according to an option, for example, by a base station or a location information receiver, and creates the emergency message containing the obtained location information.

After transmitting the emergency message, the first mobile device 100 makes an outgoing emergency call to the emergency center 300 using the DTMF tone-based phone number (209). The first mobile device 100 is connected with the emergency center 300 based on the reply to the emergency call (211).

The second user of the second mobile device 200 and an operator of the emergency center 300 perceive the emergency message from the first mobile device 100 and detect the location of the first user of the first mobile device 100. In addition, the emergency center 300 can rapidly detect the emergency of the first user according to the outgoing emergency call. Therefore, the first user can immediately receive help from the others.

In an embodiment of the present invention, as shown in FIG. 2, if the DTMF tone-based phone number corresponds to the phone number of the emergency center 300 instead of the phone number of the second mobile device 200 that is currently connected with the first mobile device 100, the system can support a three way calling service. That is, the system according to the present invention can support three way calling among the first mobile device 100, the second mobile device 200 and the emergency center 300.

Referring to FIG. 2, when the call connection has been established between the first mobile device 100 and the emergency center 300, the first mobile device 100 can check whether to set an option of three way calling. In an embodiment of the present invention, it is assumed that the first mobile device 100 can support a three way calling. If the first mobile device 100 sets a three way calling option, the first mobile device 100 can automatically generate a control event for a three way calling so that the first mobile device 100 can make a call to the second mobile device 200, to which it is connected at block 201, and the emergency center 300 to which it is connected at 221.

For example, when the first mobile device 100 makes an outgoing emergency call to the emergency center 300 in a state where the first mobile device 100 establishes a call connection with the second mobile device 200, the first mobile device 100 can establish a call connection with the emergency center 300, holding on the call connection with the second mobile device 200. If the first mobile device 100 has set a three way calling option, the first mobile device 100 can generate a control event for supporting a three way calling so that the first mobile device 100, the second mobile device 200 and the emergency center 300 can make a call to each other.

The second mobile device 200 and the emergency center 300 can make a call to each other based on the control event generated by the first mobile device 100 (221). When the second mobile device 200 and the emergency center 300 make a call to each other, the first mobile device 100, the second mobile device 200 and the emergency center 300 establish the three way call connection (223). Therefore, when the first user is in an emergency, the system according to the present invention can establish the three way call connection among the first user, the second user and the emergency center 300, so that the second user and the emergency center 300 can deal rapidly with the first user's emergency.

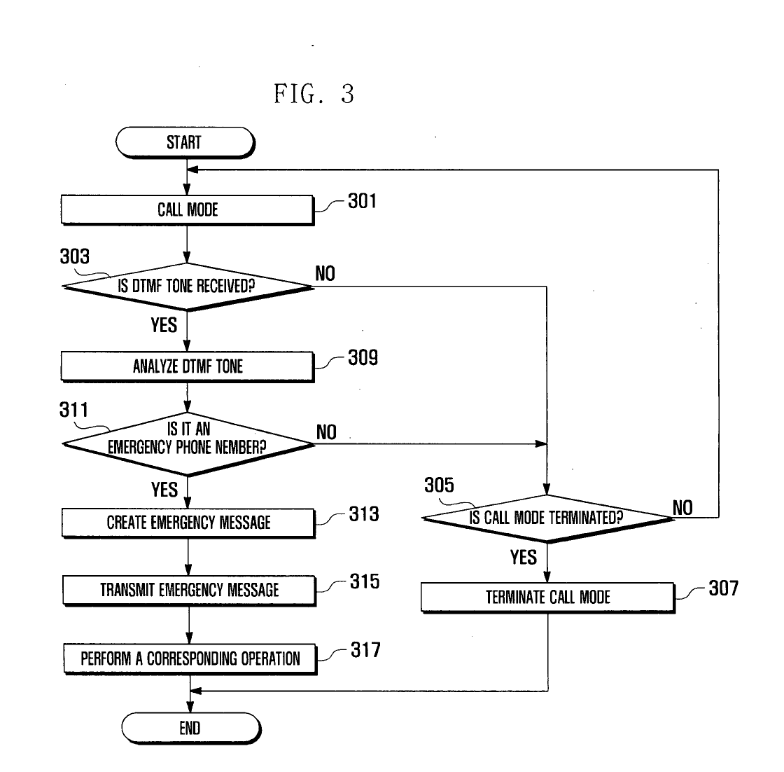

FIG. 3 illustrates a flow chart that describes a control method for supporting an emergency mode in a mobile device according to an embodiment of the present invention.

FIG. 3 explains a control method where a mobile device is operated in an emergency mode in a situation as shown in FIG. 1. Therefore, the mobile device to be described in FIG. 3 is configured in such a way that the mobile device can support the same emergency mode as the first and second mobile devices 100 and 200.

Referring to FIG. 3, the mobile device is operated in a call mode where the mobile device is establishing a call connection with another mobile device (301). The mobile device checks whether the mobile device receives DTMF tones from the other mobile device (303). If the mobile device has not received a DTMF tone from the other mobile device at block 303, the mobile device further determines whether there is a request for terminating a call mode (305). If the mobile device ascertains that there is a request for terminating a call mode at block 305, the mobile device disconnects with the other mobile device and terminates the call connection (307). On the contrary, if the mobile device ascertains that there is not a request for terminating a call mode at block 305, the mobile device returns to and proceeds with block 301. The termination of a call mode can be requested by the mobile device or the other mobile device.

Meanwhile, if the mobile device has received DTMF tones from the other mobile device at block 303, the mobile device analyzes the received DTMF tones (309). That is, when the mobile device receives DTMF tones from the other mobile device in a call mode, the mobile device can analyze the received DTMF tones and create a phone number corresponding to the DTMF tones.

After that, the mobile device determines whether the phone number created based on the DTMF tones (or DTMF tone-based phone number) corresponds to an emergency phone number (311). That is, the mobile device compares the DTMF tone-based phone number with at least one of the preset emergency phone numbers. To do this, the mobile device buffers the DTMF tone-based phone number and compares the DTMF tone-based phone number with the emergency phone numbers. Examples of the emergency phone numbers are one of the phone numbers stored in the phonebook, designated as an emergency phone number by the user, or phone numbers directly input and set by the user. The emergency phone numbers can be stored in the storage unit of the mobile device in the form of a phone book.

If the mobile device ascertains that the DTMF tone-based phone number does not correspond to an emergency phone number at block 311, the mobile device proceeds with block 305 described above. In that case, the mobile device ceases buffering the DTMF tone-based phone number and deletes the DTMF tone-based phone number. On the contrary, if the mobile device ascertains that the DTMF tone-based phone number corresponds to an emergency phone number at block 311, the mobile device creates an emergency message (313). In that case, the mobile device continues to buffer the DTMF tone-based phone number until the mobile device has transmitted the emergency message or made an outgoing emergency call. The mobile device can create an emergency message containing its location information that is acquired based on the base station or a location information receiver.

The mobile device transmits the emergency message to the other mobile device via the DTMF tone-based phone number (315). After that, the mobile device performs a corresponding operation (317). For example, the mobile device periodically checks its location information, creates an emergency message that contains its altered location information, and transmits the emergency message to the other mobile device. In addition, the mobile device releases the call connection with the other mobile device and makes an outgoing emergency call to a preset emergency phone number. For example, after the mobile device has transmitted an emergency message, the mobile device terminates a call mode with the other mobile device and then automatically makes an outgoing emergency call to the emergency center, e.g., a hospital, a fire station, a police station, etc., via a preset emergency phone number.

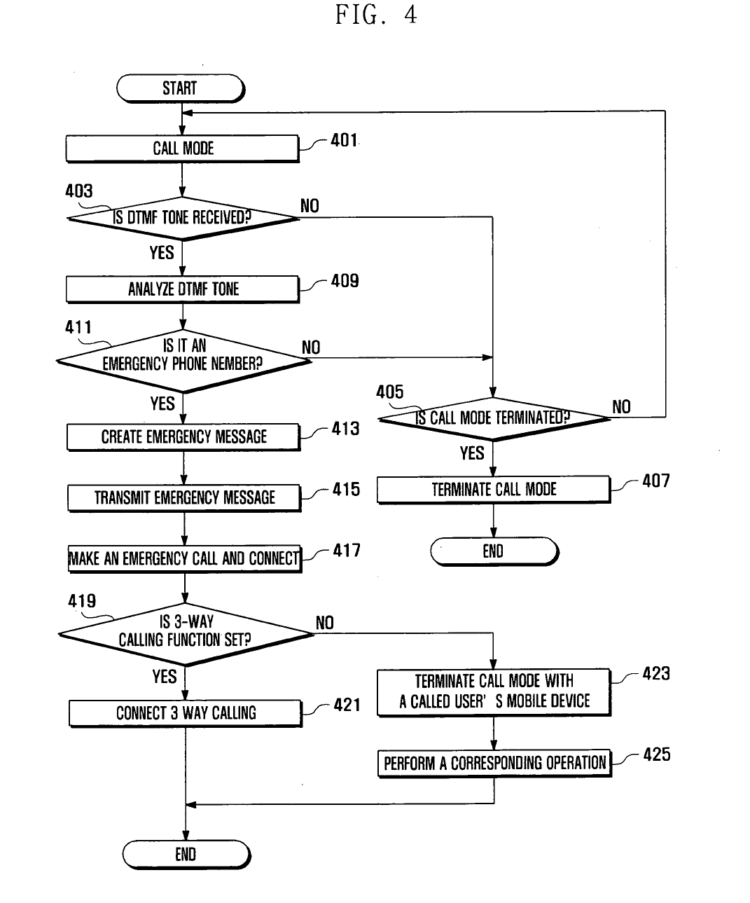

FIG. 4 illustrates a flow chart that describes a control method for supporting an emergency mode in a mobile device according to an embodiment of the present invention.

FIG. 4 explains a control method where a mobile device is operated in an emergency mode in a situation as shown in FIG. 2. Therefore, the mobile device to be described in FIG. 4 is configured in such a way that the mobile device can support the same emergency mode as the first and second mobile devices 100 and 200 and the emergency center 300.

Referring to FIG. 4, the mobile device is operated in a call mode where the mobile device establishes a call connection with another mobile device (401). The mobile device checks whether the mobile device receives DTMF tones from the other mobile device (403). If the mobile device has not received a DTMF tone from the other mobile device at block 403, the mobile device further determines whether there is a request for terminating a call mode (405). If the mobile device ascertains that there is a request for terminating a call mode at block 405, the mobile device disconnects with the other mobile device and terminates the call connection (407). On the contrary, if the mobile device ascertains that there is not a request for terminating a call mode at block 405, the mobile device returns to and proceeds with block 401. The termination of a call mode can be requested by the mobile device or the other mobile device.

Meanwhile, if the mobile device has received DTMF tones from the other mobile device at block 403, the mobile device analyzes the received DTMF tones (409). That is, when the mobile device receives DTMF tones from the other mobile device in a call mode, the mobile device can analyze the received DTMF tones and create a phone number corresponding to the DTMF tones.

After that, the mobile device determines whether the phone number created based on the DTMF tones (or DTMF tone-based phone number) corresponds to an emergency phone number (411). That is, the mobile device compares the DTMF tone-based phone number with at least one of the preset emergency phone numbers. To do this, the mobile device buffers the DTMF tone-based phone number and compares the DTMF tone-based phone number with the emergency phone numbers. Examples of the emergency phone numbers are one of the phone numbers stored in the phonebook, designated as an emergency phone number by the user, or phone numbers directly input and set by the user. The emergency phone numbers can be stored in the storage unit of the mobile device in the form of a phone book.

If the mobile device ascertains that the DTMF tone-based phone number does not correspond to an emergency phone number at block 411, the mobile device proceeds with block 405 described above. In that case, the mobile device ceases buffering the DTMF tone-based phone number and deletes the DTMF tone-based phone number. On the contrary, if the mobile device ascertains that the DTMF tone-based phone number corresponds to an emergency phone number at block 411, the mobile device creates an emergency message (413). In that case, the mobile device continues to buffer the DTMF tone-based phone number until the mobile device has transmitted the emergency message or made an outgoing emergency call. The mobile device can create an emergency message containing its location information that is acquired based on the base station or a location information receiver.

The mobile device transmits the emergency message to at least one of the other mobile device and the emergency center, via the DTMF tone-based phone number (415). For example, if the DTMF tone-based phone number is the phone number of the other mobile device, the mobile device can transmit the emergency message to the other mobile device. Alternatively, if the DTMF tone-based phone number is the phone number of the emergency center, the mobile device can transmit the emergency message to the emergency center. When the mobile device transmits the emergency message to the emergency center via the DTMF tone-based phone number, the mobile device can also extract the phone number of the other mobile device and transmit the emergency message thereto via the extracted phone number.

After transmitting the emergency message at block 415, the mobile device makes an outgoing emergency call to the emergency center via the DTMF tone-based phone number and establishes a call connection with the emergency center based on a reply by the emergency center (417). If the DTMF tone-based phone number is the phone number of the other mobile device, the mobile device may omit block 417 and the remaining blocks following block 417. When the mobile device makes an outgoing emergency call, the mobile device may hold on the call connection or release the call connection with the other mobile device according to the options or the supporting modes. In an embodiment of the present invention, it is assumed that, when the mobile device makes an outgoing emergency call at block 417, the mobile device retains the call connection with the other mobile device, i.e., the mobile device holds on the call with the other mobile device.

After that, the mobile device determines whether a three way calling function is set (419). For example, the mobile device supports a three way calling function and has set a call connection with the emergency center, the mobile device can determine whether a three way calling function is performed according to the options.

If the mobile device ascertains that a three way calling function has been set according to a preset option at 419, the mobile device establishes a three way call connection (421). For example, if a three way calling function has been set in the mobile device and an emergency occurs in the mobile device, a three way call can be established among the mobile device, the other mobile device that is holding on according to the outgoing emergency call, and the emergency center that is connected with the mobile device according to the outgoing emergency call. After establishing the three way call connection, the mobile device can perform a corresponding operation (425). For example, the mobile device periodically checks its location information, creates an emergency message that contains its altered location information, and transmits the emergency message to at least one of the other mobile device and the emergency center.

On the contrary, if the mobile device ascertains that a three way calling function has not been set according to a preset option at 419, the mobile device terminates a call mode with the other mobile device (423). That is, the mobile device releases the call connection with the other mobile device. After that, the mobile device can perform a corresponding operation, holding on the call with emergency center at block 425. For example, the mobile device periodically checks its location information, creates an emergency message that contains its altered location information, and transmits the emergency message to the emergency center.

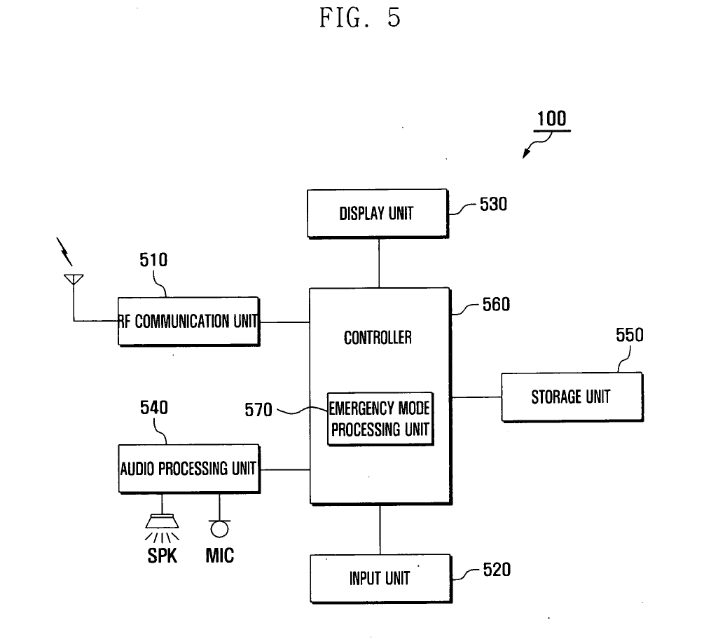

The foregoing description has explained the control method for supporting the emergency mode in a mobile device. Operations according to the method can be controlled by a controller 560 shown in FIG. 5 or implemented with a software program.

The following description explains the configuration of a mobile device for supporting an emergency mode according to an embodiment of the present invention. It should be understood that the present invention is not limited to the embodiment. That is, it will be noted that there may be many modifications from the embodiment.

FIG. 5 illustrates a schematic block diagram of a mobile device according to an embodiment of the present invention.

Referring to FIG. 5, the mobile device includes a radio frequency (RF) communication unit 510, an input unit 520, a display unit 530, an audio processing unit 540, a storage unit 550, and a controller 560.

The RF communication unit 510 performs communication for the mobile device. That is, the RF communication unit 510 establishes a communication channel with a network, for example, a base station, etc., according to a preset mode, under the control of the controller 560 and transmits or receives signals related to RF communication, such as voice and video, etc., and signals related to data communication, such as message and Internet, etc. The RF communication unit 510 is configured to include an RF transmitter for up-converting the frequency of signals to be transmitted and amplifying the signals and an RF receiver for low-noise amplifying received RF signals and down-converting the frequency of the received RF signals. As shown in FIGS. 1 to 4, the RF communication unit 510 transmits signals corresponding to an outgoing emergency call to an external device via a communication channel, under the control of the controller 560.

The communication channel includes mobile communication channels and Internet communication channels. Examples of the mobile communication channels are Code Division Multiple Access (CDMA), Time Division Multiple Access (TDMA), Orthogonal Frequency Division Multiple Access, etc. Examples of the Internet communication channels are a wired Internet, wireless Internet, etc. The RF communication unit 510 receives DTMF tones when the mobile device is operated in a call mode. The RF communication unit 510 also transmits an emergency message and makes an emergency call in an emergency mode, operated based on the DTMF tones, to the external device, via the preset communication channel. If the system according to the present invention supports Internet-based communication, the RF communication unit 510 may be replaced with an Internet communication module (not shown).

The input unit 520 creates input signals corresponding to number and letter information and signals for setting and controlling a variety of functions of the mobile device and outputs them to the controller 560. The input unit 520 includes keys and function keys for allowing the user to input and set information and functions. The function keys include direction keys, side keys, shortcut keys, etc., which are set to perform specific functions. The input unit 520 may be implemented with, according to the type of mobile device, one of a touch pad, a touch screen, a keypad of a general key arrangement (e.g., 3×4 key arrangement), or a QWERTY keypad, or a combination thereof. In particular, the input unit 520 creates DTMF tones based on a user's input when the mobile device is operated in a call mode. That is, the input unit 520 outputs input signals, created in the call mode, to the controller 560. The DTMF tones may also be generated by the key signals as the keypad is operated or by the touch signals as the virtual keypad is operated on the touch screen.

The display unit 530 shows a variety of screens when the mobile device executes corresponding functions, for example, a boot screen, an idle screen, a menu screen, a list screen, a playback screen, etc. That is, the display unit 530 can display various screens related to the states and functions of the mobile device. The display unit 530 can be implemented with a liquid crystal display (LCD), an organic light emitting diode (OLED), or the like. In particular, if the display unit 530 is implemented with a touch screen, the display unit 530 can also serve as an input device. When the display unit 530 is implemented with a touch screen and serves to perform an input function, the display unit 530 provides a virtual keypad on the touch screen when the mobile device is operated in a call mode. The display unit 530 generates DTMF tones when the user inputs his/her input on the virtual keypad. The display unit 530 generates the touch signals by a touch of the virtual keypad in the call mode and outputs the touch signals to the controller 560.

The audio processing unit 540 includes a speaker SPK for reproducing audio signals and a microphone MIC for receiving audio signals, such as a user's voice, etc. The audio processing unit 540 is connected with the speaker SPK and the microphone MIC. The audio processing unit 540 receives audio signals via the microphone MIC and outputs audio data to the controller 560. The audio processing unit 540 converts analog audio signals from the microphone MIC into digital audio signals and outputs the digital audio signals to the controller 560. The audio processing unit 540 also converts the digital audio signals from the controller 560 into analog audio signals and outputs the digital audio signals via the speaker SPK. In an embodiment of the present invention, the audio processing unit 540 can output various audio signals generated by the mobile device to the speaker SPK according to a user's selection. Examples of the various audio signals are an audio signal according to the reproduction of media data sound effects according to the execution of functions.

The storage unit 550 stores data created and used in the mobile device. The data may be data generated when the mobile device is operated. Examples of the data are call log, messages, phone book, audio, video, broadcast, photographs, etc. The data may also be any type of data that is created by the mobile device or is downloaded from external systems, for example, a web server, other mobile device, a personal computer, etc. The data may further be applications for directly executing corresponding functions/menus in the mobile device.

The storage unit 550 can store software for controlling the emergency mode. The storage unit 550 can also store information created when the mobile device is used and information for supporting the emergency service. Examples of the information are at least one emergency phone number, location information, options related to three way calling service, and/or options for setting an emergency message transmission mode.

The storage unit 550 includes at least one buffer for temporarily storing data generated when the mobile device executes the functions. For example, the storage unit 550 can buffer DTMF tones received when the mobile device is operated in an emergency mode, a phone number extracted based on the received DTMF tones, etc. The storage unit 550 may also be implemented with all types of recoding media that can be installed inside or outside the mobile device, for example, a smart card. The storage unit 550 may include Random Access Memory (RAM), Read Only Memory (ROM), flash memory, etc. The storage unit 540 may include one or two integrated memory, for example, Multi-Chip Package (MCP) memory, etc., where the integrated memory includes RAM, ROM, or flash memory, or a combination thereof.

The controller 560 controls the entire operation of the mobile device and the signal flow among the elements in the mobile device. Examples of the elements are the RF communication unit 510, input unit 520, display unit 530, audio processing unit 540, and storage unit 550.

The controller 560 controls operations for an emergency mode and an emergency service. That is, the controller 560 controls the entire operation related to an emergency mode and an emergency service based on the DTMF tones received in a call mode. When the controller 560 receives DTMF tones in a call mode, the controller 560 creates a phone number based on the received DTMF tones (DTMF tone-based phone number). The controller 560 compares the DTMF tone-based phone number with at least one preset emergency phone number and extracts an emergency phone number consistent with the DTMF tone-based phone number. If the controller 560 has extracted an emergency phone number consistent with the DTMF tone-based phone number, the controller 560 creates an emergency message and transmits the emergency message via the extracted emergency phone number. The controller 560 controls the outgoing emergency call based on the extracted phone number. The controller 560 can acquire the location information about the mobile device and include the location information in the emergency message.

As described above, the controller 560 can control the entire function and operation related to the emergency mode and the emergency service. The functions controlled by the controller 560 can be implemented with a software program.

The controller 560 includes an emergency mode processing unit 570.

When the mobile device is operated in an emergency mode during a call, the emergency mode processing unit 570 processes the entire control operation related to the emergency mode. The emergency mode processing unit 570 operates the emergency mode when the mobile device extracts a phone number based on DTMF tones received in the call mode and the extracted phone number corresponds to an emergency phone number.

The emergency mode processing unit 570 creates an emergency message containing the location information of the mobile device when the mobile device is operated in the emergency mode. The emergency mode processing unit 570 controls the transmission of the emergency message via the DTMF tone-based phone number. If the DTMF tone-based phone number is the phone number of the other mobile device that is currently connected with the mobile device, the emergency mode processing unit 570 transmits the emergency message to the other mobile device. Likewise, if the DTMF tone-based phone number corresponds to an emergency center, the emergency mode processing unit 570 transmits the emergency message to the emergency center and also to the other mobile device if the other mobile device is connected with the mobile device according to the option. The emergency mode processing unit 570 controls an outgoing emergency call based on the DTMF tone-based phone number in the emergency mode. The emergency mode processing unit 570 can generate a control event for supporting three way calling among the mobile device, and the emergency center and the other mobile device that are connected with the mobile device according to the outgoing emergency call during the emergency mode.

The function of the emergency mode processing unit 570 can be implemented with a software program that is loaded on the controller 560. In that case, the controller 560 can perform the control function of the emergency mode processing unit 570.

Although the configuration of the mobile device according to an embodiment of the present invention is schematically shown in FIG. 5, it should be understood that the present invention is not limited to the embodiment. For example, the mobile device may further include a baseband module for providing a mobile communication service. The baseband module may be installed with the controller 550 and the RF communication unit 510, together or separately.

Although it is not shown in FIG. 5, the mobile device may further include a location information receiver for acquiring location information about the mobile device, such as GPS, a short range communication module for performing short-range communication, a camera module for capturing still images or moving images, an interface unit for transmitting and receiving data in wired or wireless mode, an Internet communication module for performing an Internet function and supporting an Internet-based calling function via the Internet, a digital broadcast module for receiving and reproducing digital broadcasts, etc. With the convergence of digital devices, there may be many digital devices and modifications thereof, not listed in the application, and, it will be appreciated that they can also be included in the mobile device. Also, it will be appreciated that, according to the purposes, the mobile device may be implemented by omitting a particular element from the configuration shown in FIG. 5 or replacing it with other elements.

It will be noted that the mobile device according to the present invention includes all types of devices for supporting a mobile communication-based calling function, an Internet-based calling function, and an emergency mode. For example, the mobile device can be applied to all information communication devices, multimedia devices, and their applications, such as, mobile communication terminals supporting various types of communication protocols, a portable multimedia player (PMP), a digital broadcast player, a personal digital assistant (PDA), audio playback device (e.g., MP3 player), a mobile game player, a wired/wireless phone, a smart phone, etc.

As described above, the emergency mode operating method, according to the present invention, can extract an emergency phone number from the DTMF tone received in a call mode by the mobile device and can transmit an emergency message or make an emergency call based on the extracted emergency phone number. Therefore, the mobile device user can utilize an emergency service while the mobile device is busy. That is, while the user is on the line, he/she can use an emergency service that is automatically provided, based on a DTMF tone transmitted from the other mobile device, without additional operations.

For example, when a user gets in an emergency during the call, e.g., shock, paralysis, driving accidents, the user can transmit an emergency message or make an emergency call, based on a DTMF tone transmitted from the other user. Therefore, while the user is in an emergency that occurs during the call, he/she can report his/her location to an emergency center and can deal rapidly with the corresponding procedures to receive help from the other user via three way calling.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc., that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An emergency mode operating method of a mobile device, comprising:
receiving Dual Tone Multi-Frequency (DTMF) tones from the other mobile device when the mobile device is operated in a call mode;
acquiring an emergency phone number using a phone number based on the received DTMF tones; and
operating an emergency mode based on the acquired emergency phone number.

2. The method of claim 1, wherein acquiring an emergency phone number comprises:
creating a phone number corresponding to the received DTMF tones;
comparing the created phone number with at least one preset emergency phone number; and
acquiring a phone number consistent with the at least one preset emergency phone number.

3. The method of claim 2, wherein operating an emergency mode comprises:
operating the emergency mode when the phone number based on the DTMF tones corresponds to the emergency phone number.

4. The method of claim 3, wherein operating an emergency mode comprises:
at least one of transmitting an emergency message and making an outgoing emergency call using the phone number based on the DTMF tones.

5. The method of claim 4, wherein operating an emergency mode comprises:
transmitting the emergency message to the other mobile device if the phone number based on the DTMF tones is a phone number of the other mobile device that is currently connected with the mobile device.

6. The method of claim 4, wherein operating an emergency mode comprises:
transmitting, if the phone number based on the DTMF tones is a phone number of an emergency center, the emergency message to at least one of the emergency center and the other mobile device that is currently connected with the mobile device; and
making an outgoing emergency call via the phone number based on the DTMF tones after the emergency message has been transmitted.

7. The method of claim 6, further comprising:
performing a three way call among the mobile device, the other mobile device and the emergency center after the outgoing emergency call has been made.

8. A mobile device comprising:
a radio frequency (RF) communication unit configured to receive Dual Tone Multi-Frequency (DTMF) tones when the mobile device is operating in a call mode and transmit an emergency message and an outgoing emergency call, created in an emergency mode, via a communication channel; and
a controller configured to operate the emergency mode if a phone number based on the received DTMF tones is a preset emergency phone number.

9. The mobile device of claim 8, wherein the controller is configured to compare the phone number based on the received DTMF tones with at least one preset emergency phone number and operate the emergency mode if the phone number based on the received DTMF tones corresponds to the emergency phone number.

10. The mobile device of claim 9, wherein the controller comprises:
an emergency mode processing unit configured to extract the phone number based on the DTMF tones if the mobile device is operated in an emergency mode during a call, and process transmission of an emergency message or an outgoing emergency call if the extracted phone number corresponds to the emergency phone number.

11. The mobile device of claim 10, wherein the emergency mode processing unit is configured to create an emergency message containing location information about the mobile device when the mobile device is operated in an emergency mode, and control transmission of the emergency message using the phone number based on the DTMF tones.

12. The mobile device of claim 11, wherein the emergency mode processing unit is configured to control transmission of the emergency message to the mobile device if the phone number based on the DTMF tones is the phone number of the other mobile device that is currently connected with the mobile device.

13. The mobile device of claim 11, wherein the emergency mode processing unit is configured to control transmission of the emergency message to at least one of the emergency center and the other mobile device that is currently connected to the mobile device if the phone number based on the DTMF tones is the phone number of the emergency center.

14. The mobile device of claim 13, wherein the emergency mode processing unit is configured to control transmission of an outgoing emergency call using the phone number based on the DTMF tones after the emergency message has been transmitted.

15. The mobile device of claim 14, wherein the emergency mode processing unit is configured to create a control event for performing three way calling among the mobile device, the other mobile device and the emergency center after the outgoing emergency call has been made.

16. A mobile device comprising:
a radio frequency (RF) communication unit configured to:
receive Dual Tone Multi-Frequency (DTMF) tones when the mobile device is operating in a call mode; and
a controller configured to
create a phone number corresponding to the received DTMF tones,
compare the created phone number with at least one preset emergency phone number; and
operate in an emergency mode if a phone number based on the received DTMF tones is a preset emergency phone number.

17. The mobile device of claim 16, wherein the controller comprises:
an emergency mode processing unit configured to extract the phone number based on the DTMF tones, if the mobile device is operating in an emergency mode during a call, and process transmission of an emergency message or an outgoing emergency call if the extracted phone number corresponds to the emergency phone number.

18. The mobile device of claim 17, wherein the emergency mode processing unit is configured to create an emergency message containing location information about the mobile device when the mobile device is operating in an emergency mode, and control transmission of the emergency message using the phone number based on the DTMF tones.

19. The mobile device of claim 18, wherein the emergency mode processing unit is configured to control transmission of the emergency message to the mobile device if the phone number based on the DTMF tones is the phone number of the other mobile device that is currently connected with the mobile device.

20. The mobile device of claim 19, wherein the emergency mode processing unit is configured to control transmission of the emergency message to at least one of the emergency center and the other mobile device that is currently connected to the mobile device if the phone number based on the DTMF tones is the phone number of the emergency center.
